(19) United States
(12) Patent Application Publication
(10) Pub. No.: US 2012/0055281 A1
(43) Pub. Date: Mar. 8, 2012

(54) CENTRIFUGAL FORCE PENDULUM

(75) Inventor: Christian Huegel, Rheinau (DE)

(73) Assignee: SCHAEFFLER TECHNOLOGIES GMBH & CO. KG, Herzogenaurach (DE)

(21) Appl. No.: 13/233,759

(22) Filed: Sep. 15, 2011

Related U.S. Application Data
(63) Continuation of application No. PCT/DE2010/000217, filed on Feb. 26, 2010.

(30) Foreign Application Priority Data
Mar. 16, 2009 (DE) 102009013403.4

(51) Int. Cl. F16F 15/14

(52) U.S. Cl. 74/574.2

(57) ABSTRACT

The invention relates to a centrifugal force pendulum (1), in particular for an arrangement in a drive train of a motor vehicle, comprising a pendulum flange (2) rotating about a rotational axis and a plurality of absorber masses (6) arranged on the flange over the circumference thereof, wherein in each case two absorber masses (6) located opposite of each other on the sides of the pendulum flange are connected to each other through webs (9), which each extend through an opening (3) in the pendulum flange so as to form absorber mass pairs (8). At the same time, cutouts (4) for receiving the absorber masses are provided in the pendulum flange. In order to achieve an optimization of the available circumference of the pendulum flange for accommodating the openings and cutouts, the adjoining webs of two adjoining absorber mass pairs are guided through a single opening.

### CROSS-REFERENCE TO RELATED APPLICATIONS

This application is filed under 35 U.S.C. §120 and §365(c) as a continuation of International Patent Application No. PCT/DE2010/000217 filed Feb. 26, 2010, which application claims priority from German Patent Application No. DE 10 2009 013 403.4 filed Mar. 16, 2009, which applications are incorporated herein by reference in their entireties.

### FIELD OF THE INVENTION

The invention relates to a centrifugal force pendulum including a pendulum flange and absorber masses that are arranged on both sides of the pendulum flange and distributed over the circumference of the pendulum flange and pivotable within limits relative to the pendulum flange.

### BACKGROUND OF THE INVENTION

Centrifugal force pendulums are known as torsion vibration absorbers with respect to their function in particular from their use in drive trains of motor vehicles, e.g., from DE 10 2004 011 830 A1. Herein absorber masses are arranged pivotable within limits at a pendulum flange which is driven by a drive unit that is configured, e.g., as an internal combustion engine which is subject to torsion vibrations. Due to the pendulum movements of the absorber masses relative to the pendulum flange caused by the different rotational accelerations of the pendulum flange the torsion vibrations are absorbed.

Thus absorber masses can be arranged on both sides of the pendulum flange, wherein axially opposite absorber masses can be connected through bars to form absorber mass pairs. Thus, the webs move in openings which are adapted with respect to their shapes to the pendulum travel of the absorber mass pairs. The support for the absorber mass pairs at the pendulum flange is provided through cut outs introduced into the absorber mass pairs, wherein the cut outs are configured complementary to the cuts outs in the pendulum mass flange, wherein roller elements roll in the cut outs. This leads to an arrangement of openings in cut outs in tight sequence over the circumference of the pendulum flange, so that the oscillation angle of the absorber mass pairs is limited. Simultaneously a safe support of the absorber mass pairs is provided at the pendulum flange as a function of the distance of the support of the absorber mass pairs through the roller elements at the cut outs of the pendulum flange.

### BRIEF SUMMARY OF THE INVENTION

Thus it is the object of the invention to provide a centrifugal force pendulum for a drive train or a drive train with a centrifugal force pendulum of this type, wherein the centrifugal force pendulum facilitates for comparable oscillation angles increased distances for the bearing locations of the absorber mass pairs in circumferential direction and/or facilitates increased oscillation angles for comparable distances.

The object is achieved through a centrifugal force pendulum including a pendulum flange rotating about a rotating axis and absorber masses arranged moveable within limits and arranged along the circumference of the pendulum flange on both sides of the pendulum flange, wherein absorber masses respectively arranged opposite to one another at the pendulum flange are connected with one another through webs to form absorber mass pairs, wherein the webs reach through openings recessed into the pendulum flange and at least one opening receives two webs of different absorber mass pairs. Through receiving two webs in one opening an intermediary portion can be omitted which has to be provided for manufacturing reasons and reasons of stability of the pendulum flange between the openings, wherein the intermediary portion depending on the thickness can have a dimension of several millimeters, e.g., 6 mm for a pendulum flange that it 4 mm thick. The omitted intermediary portion can be used for a larger distance of the cut outs in circumferential direction when the cut outs for supporting the absorber mass pairs are distributed accordingly. Alternatively the cut outs in circumferential direction can be cut out further so that larger vibration angles can be adjusted. It is appreciated that depending on the requirements for vibration absorption respective mixed forms with partially increased vibration angle and partial larger distance of the cut outs for receiving the roller elements can be provided. The webs can be formed by rivets so that the absorber masses that are arranged opposite to one another in axial direction are riveted together through at least two rivets arranged at end sides in circumferential direction. The openings can be configured so that at least a portion of the recessed surface of both webs is covered during a movement of the absorber mass pairs. Thus, a mutual contact of the absorber masses during pivoting is excluded for a uniform movement of the absorber mass pairs through the running surfaces of the cut outs for the roller element and the pendulum flange in the absorber masses.

According to an advantageous embodiment the two bars of two absorber mass pairs that are arranged adjacent to one another in circumferential direction are received in a single opening. The opening forms a preferably semi circular cut out that is open towards a radial inside in order to minimize the cut out mass. This corresponds substantially to the running surface of the webs during pivoting. This shape is substantially determined through the shape of the cut outs in the pendulum flange and in the absorber masses, wherein the shapes of the cut outs are adapted to the vibration paths of the absorber masses relative to the pendulum flange, wherein the absorber masses are arranged for providing vibration absorption. Thus, the paths of the absorber masses are defined in particular by the respective shapes of the cut outs and their slopes in radial and in circumferential direction so that contacts of the roller elements at the limitations of the cut outs do not provide limitations of the pivot ranges of the absorber masses relative to the pendulum flange or provide these limitations at the most in exceptional cases.

According to a preferred embodiment the absorber masses are configured so that the absorber mass pairs adjacent in circumferential direction reach over one another in radial direction as a function of their movement condition relative to the pendulum flange.

Furthermore it has proven advantageous when openings and cut outs that are adjacent in the pendulum flange have a distance that corresponds to 1.5 times the thickness of the pendulum flange. This distance of the intermediary portions between the openings and the cut outs facilitates obtaining an optimized and simultaneously stable arrangement of the openings and holes without having to restrict the extension of the cut outs in circumferential direction or the distance of the cut outs required for stabilizing the absorber mass pairs which are necessary for adjusting the vibration angle.

According to the invention the centrifugal force pendulum is used in a drive train of a motor vehicle. As a solution a drive train is proposed with a drive unit and a transmission in a motor vehicle in which the previously described centrifugal force pendulum which is configured with features according to the invention is arranged between the drive unit and the transmission. Thus, the centrifugal force pendulum can be used in combination with a torsion vibration damper with one or plural stages. It has proven advantageous to arrange the centrifugal force pendulum in parallel with a damper stage and, e.g., integrated in the torsion vibration damper. This way the centrifugal force pendulum can be received by itself or in combination with a torsion vibration damper in a housing of a hydrodynamic torque converter. Thus, the torsion vibration damper can be provided together with the centrifugal force pendulum in a function of a dual mass flywheel or as a divided flywheel. It is appreciated that a dual mass flywheel of this type can also be used in combination with a dry clutch, a wet clutch or embodiments of the clutches as twin clutch, e.g., for a twin clutch transmission.

### BRIEF DESCRIPTION OF THE DRAWINGS

The invention is described in detail with reference to embodiments illustrated in FIGS. 1 through 6, wherein:

FIG. 1 illustrates a prior art pendulum flange in a partial view;

FIG. 2 illustrates a pendulum flange according to the invention in a partial view;

FIG. 3 illustrates a partial view of a pendulum flange with an enlarged distance of the cut outs for receiving the absorber masses;

FIG. 4 illustrates a partial view of a pendulum flange with an enlarged distance of the cut outs for receiving the absorber masses and an enlargement of the absorber masses;

FIG. 5 illustrates a partial view of a centrifugal force pendulum in a center position; and

FIG. 6 illustrates a partial view of the centrifugal force pendulum in FIG. 5 in a deflected condition.

### DETAILED DESCRIPTION OF THE INVENTION

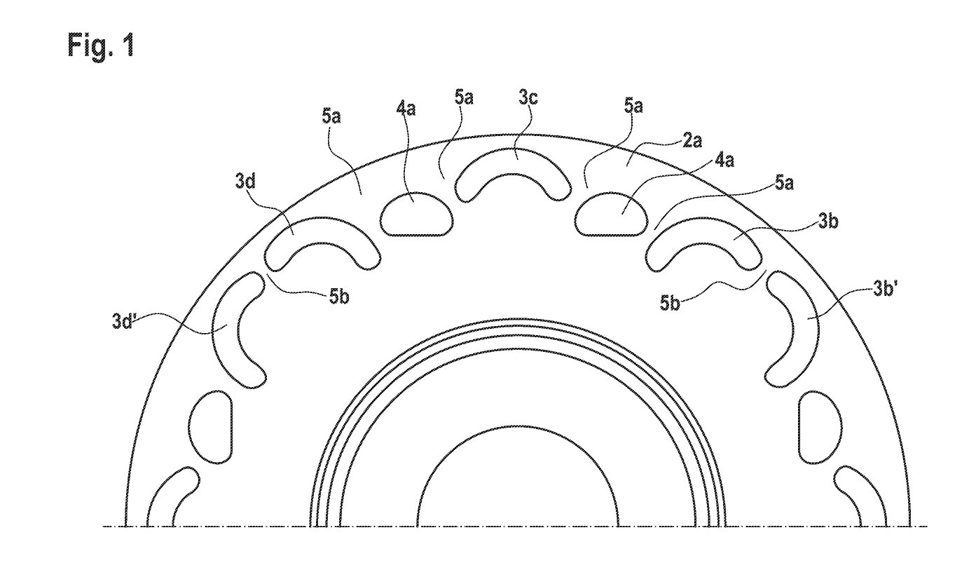

FIG. 1 illustrates a pendulum flange 2a of a prior art centrifugal force pendulum. Thus, openings 3b, 3c, 3d for the webs are provided, wherein the webs connect two respective axially offset absorber masses which are respectively arranged at one side surface of the pendulum flange 2a and connect them to form a absorber mass pair in that one respective web, e.g., a rivet riveted together with both absorber masses reaches through one respective opening of the openings 3b, 3c and 3d. Thus the shape of the openings 3b, 3c, 3d is predetermined by the possible path of the absorber mass pairs during pivoting relative to the pendulum flange 2a. This path is predetermined by the cutouts 4a and the cutouts which are respectively provided in the absorber masses, wherein a rolling element respectively rolls in the cutouts 4a and the respectively opposite cutouts of the absorber masses. The openings 3b′, 3d′ are the pass through openings for the webs of the adjacent absorber mass pairs.

For stability reasons of the pendulum flange 2a the intermediary portions 5a have to be maintained between the cutouts 4a and the openings 3b, 3c, 3d and the intermediary portions 5b have to be maintained between the openings 3b, 3b′ or 3d, 3d′. For a predetermined number of absorber mass pairs the oscillation angle which is influenced by the width of the cut outs 4a and the distance of the cut outs 4a in circumferential direction which influences the stable reception of the absorber mass or the absorber mass pairs at the pendulum flange is predetermined. This means the centrifugal force pendulum cannot be expanded any more with respect to its capacity predetermined by the vibration angle and the distance of the cutouts 4a under the predeterminations of the diameter, the thickness of the pendulum flange 2a which predetermines the dimensions of the intermediary portions 5a, 5b.

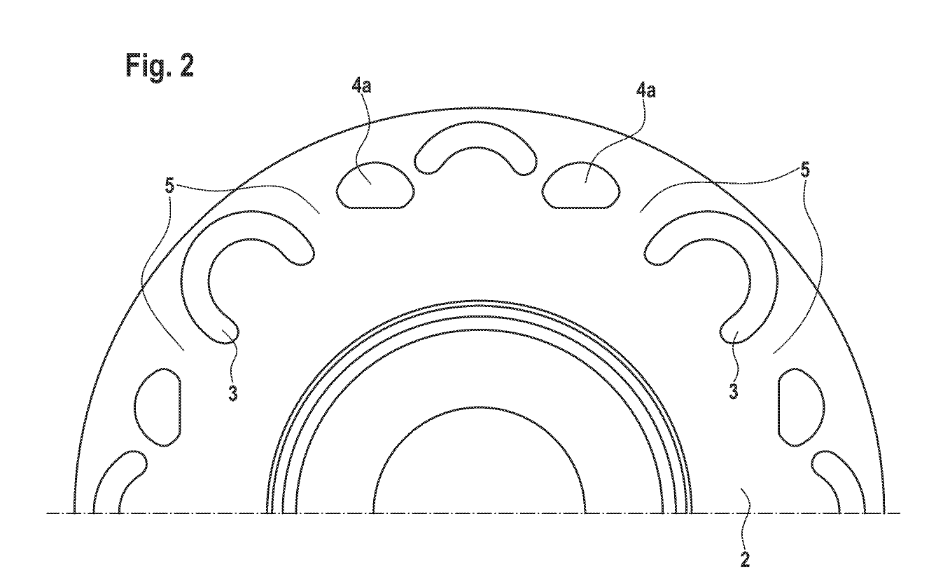

FIG. 2 provides the pendulum flange 2 according to the invention in which the openings 3 are configured semi circular, wherein the openings essentially correspond to an overlap of the openings 3b, 3b′ and 3d, 3d′ of FIG. 1. The openings can be combined partially overlapping with the opening 3 so that not only the intermediary portions 5b illustrated in FIG. 1 can be omitted, but so that the webs can at least partially travel along the paths of the webs of the adjacent absorber mass pairs. A respective correction of the position of the webs thus causes intermediary portions 5 broadened in circumferential direction through the space savings through the opening 3 which facilitate a more stable configuration of the centrifugal force pendulum or a configuration with a greater oscillation angle for a respective movement and/or broadening of the cut outs 4a which for illustration purposes are still illustrated at the position illustrated in FIG. 1.

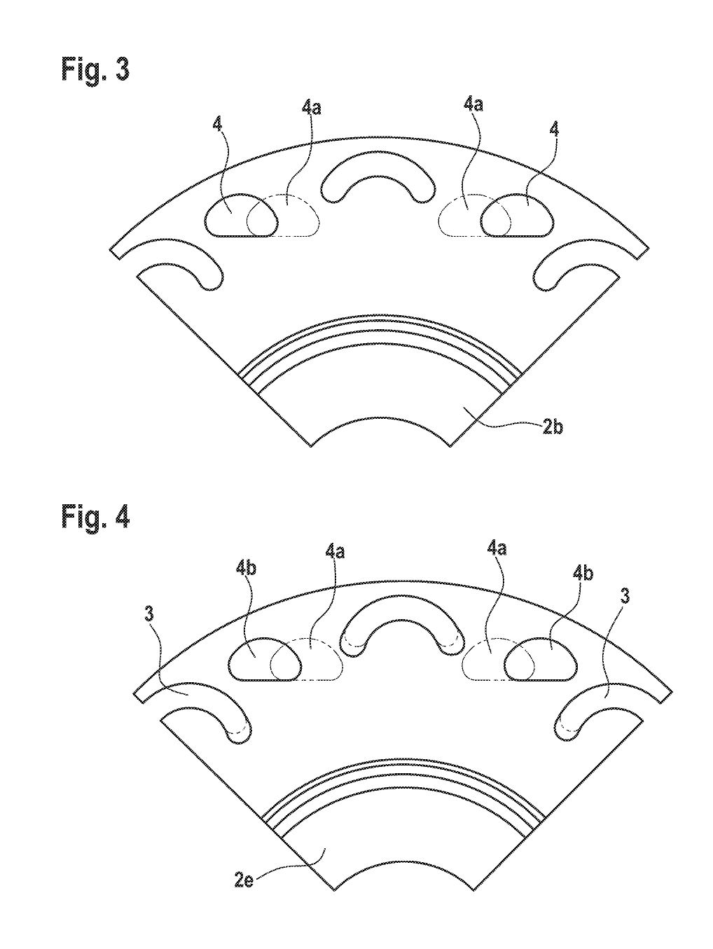

For this purpose FIGS. 3 and 4 illustrate respective embodiments of improved pendulum flanges 2b, 2c. The pendulum flange 2b of FIG. 3 illustrates further offset cut outs 4 compared to the cut outs 4a illustrated in the position with dashed lines in FIGS. 1 and 2 which facilitates a more stable reception of the absorber mass pairs. The pendulum flange 2c includes cut outs 4b which are wider relative to the dashed cut outs 4a of FIGS. 1 and 2 and which are offset further so that a more stable reception and a greater vibration angle of the absorber mass pairs can be provided. Accordingly the openings 3 are adapted at their ends to the greater vibration angle which causes a greater pivot angle of the webs.

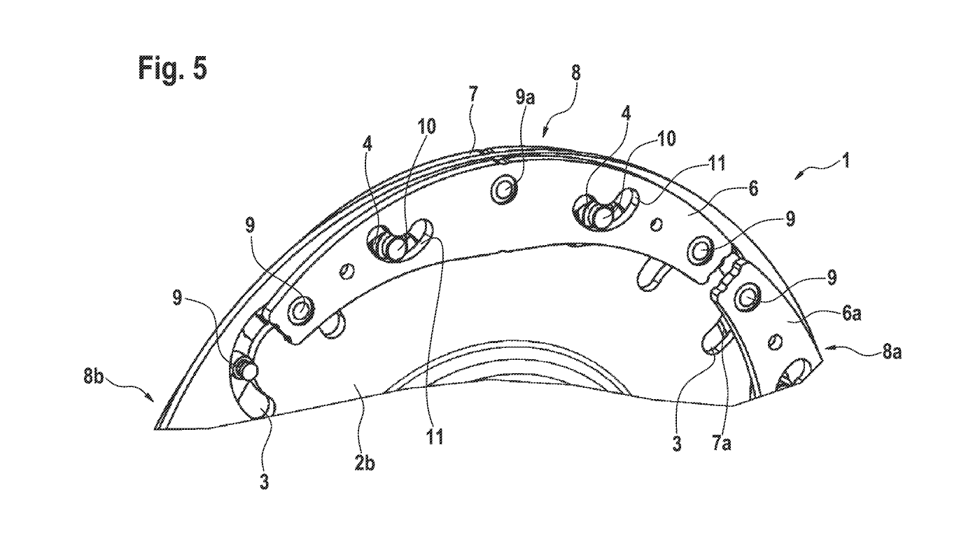

FIG. 5 illustrates the centrifugal force pendulum with the pendulum flange 2b in a partial view. In a similar manner the pendulum flange 2c of FIG. 4 or a pendulum flange provided with other distances and/or widths of the cut outs 4 can be used. The absorber masses 6, 6a, 7, 7a arranged on both sides of the pendulum flange 2b and distributed over the circumference form plural absorber mass pairs 8, 8a, 8b, preferably four absorber mass pairs distributed over the circumference which are connected with one another through the webs 9, 9a, e.g., rivets. The webs 9 thus reach through the openings 3, the webs 9a reach through openings as they are illustrated in FIG. 1 as openings 3c. Respectively, adjacent webs 9 of two absorber mass pairs, e.g., of the absorber mass pairs 8, 8a move into the opening 3 when the absorber mass pairs pivot. For reasons of clarity the front absorber mass of the left absorber mass pair is not illustrated.

The guidance and support of the absorber mass pairs 8, 8a, 8b relative to the pendulum flange 2b is provided through rolling elements 10 which roll in the cut outs 4 of the pendulum flange and also in the cut outs that are respectively introduced in the same manner into the absorber masses 6, 6a axially connected with one another. The sum of the two profiles of the cut outs 4, 11 yields the path of the absorber masses when pivoting and thus the absorber function. The centrifugal force pendulum 1 is illustrated in the center position, e.g., for a stopped drive unit.

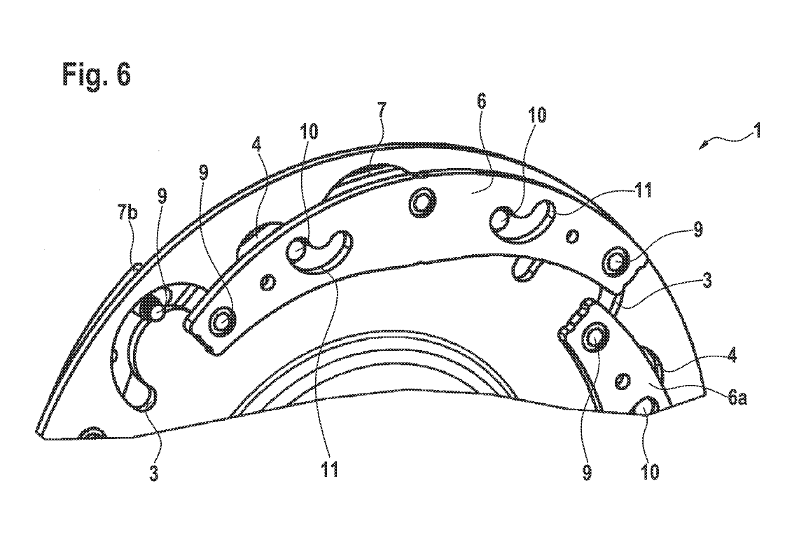

FIG. 6 illustrates the centrifugal force pendulum 1 of FIG. 5 in fully displaced condition, e.g., while compensating a torque spike. The absorber masses 6, 6a, 7b which are visible herein, the forward left absorber mass in turn is omitted, are moved along the cut outs 4, 11 through the roller elements 10 and thus reach over one another in radial direction. The webs 9 of adjacent absorber mass pairs thus extend in the openings 3 that are cut out accordingly without contacting.

### REFERENCE NUMBERS

1 centrifugal force pendulum
2 pendulum flange
2a pendulum flange
2b pendulum flange
2c pendulum flange
3 opening
3a opening
3b opening
3b′ opening
3c opening
3d opening
3d′ opening
4 cut out
4a cut out
4b cut out
5 intermediary portion
5a intermediary portion
5b intermediary portion
6 absorber mass
6a absorber mass
7 absorber mass
7a absorber mass
7b absorber mass
8 absorber mass pair
8a absorber mass pair
8b absorber mass pair
9 web
9a web
10 rolling element
11 cut out

What I claim is:

1. A centrifugal force pendulum (1) comprising a pendulum flange (2, 2b, 2c) rotating about a rotation axis and absorber masses (6, 6a, 7, 7a, 7b) arranged at the pendulum flange on both sides moveable within limits and distributed along the circumference of the pendulum flange, wherein respective absorber masses (6, 6a, 7, 7a, 7b) arranged opposite to one another at the pendulum flange (2, 2b, 2c) are connected with one another through webs (9, 9a) to form absorber mass pairs (8, 8a, 8b) and the webs (9, 9a) reach through openings (3, 3c) recessed through the pendulum flange (2, 2b, 2c), wherein at least one opening (3) receives two webs (9, 9a) of different absorber mass pairs (8, 8a, 8b).

2. The centrifugal force pendulum (1) recited in claim 1, wherein two respective webs (9) of two absorber mass pairs (8, 8a, 8b), wherein the webs are adjacent in circumferential direction, are received in an opening (3).

3. The centrifugal force pendulum (1) recited in claim 1, wherein the opening (3) forms a semi circular radially inward opened cutout.

4. The centrifugal force pendulum (1) recited in claim 1, wherein the absorber mass pairs (8, 8a, 8b) are moveable relative to the pendulum flange (2, 2b, 2c) within limits in circumferential direction and within limits in radial direction.

5. The centrifugal force pendulum (1) recited in claim 1, wherein the absorber masses (6, 6a, 7, 7a, 7b) of absorber mass pairs (8, 8a, 8b) adjacent to one another in circumferential direction radially reach over one another as a function of a displacement condition relative to the pendulum flange (2, 2b, 2c).

6. The centrifugal force pendulum (1) recited in claim 1, wherein the absorber masses (6, 6a, 7, 7a, 7b) of an absorber mass pair (8, 8a, 8b) include at least two cutouts (11) respectively aligned with one another, wherein rolling elements (10) roll in the cut outs, wherein the rolling elements simultaneously roll in corresponding cut outs (4) of the pendulum flange (2, 2b, 2c).

7. The centrifugal force pendulum (1) recited in claim 1, wherein openings (3, 3c) adjacent in circumferential direction and cut outs (4) in the pendulum flange (2, 2b, 2c) have a distance of 1.5 times the thickness of the pendulum flange (2, 2b, 2c).

8. The hydrodynamic torque converter with a centrifugal force pendulum (1) recited in claim 1 arranged in the housing of the hydrodynamic torque converter.

9. The hydrodynamic torque converter recited in claim 8, wherein the centrifugal force pendulum (1) is arranged parallel to a torsion vibration damper or is an element of the torsion vibration damper.

10. A dual mass fly wheel comprising a centrifugal force pendulum (1) recited in claim 1.
